(19) United States
(12) Patent Application Publication
(10) Pub. No.: US 2021/0170450 A1
(43) Pub. Date: Jun. 10, 2021

(54) A MAIL SORTING INSTALLATION WITH A TRAY CONVEYOR AND AN ELEVATOR ROBOT

(71) Applicant: SOLYSTIC, Bagneux (FR)

(72) Inventors: Cedric Milord, Marches (FR); Frederic Mestrallet, Etoile sur Rhone (FR); Karine Crest, Etoile sur Rhone (FR); Laurent Pellegrin, Livron (FR)

(21) Appl. No.: 16/070,822

(22) PCT Filed: Jun. 15, 2018
(86) PCT No.: PCT/FR2018/051427

§ 371 Date: Jul. 18, 2018

(30) Foreign Application Priority Data
Aug. 3, 2017 (FR) 1757464

(51) Int. Cl. B07C 3/00; B07C 3/02

(52) U.S. Cl. CPC B07C 3/008; B07C 3/02

(57) ABSTRACT

An installation for sorting mailpieces (A) includes a sorting conveyor with sorting outlets (2) and storage trays (3), and further includes a tray conveyor (4) disposed along the sorting conveyor under the sorting outlets, and a shuttle robot (5) suitable for being controlled by a monitoring and control unit (6) for automatically taking hold of a tray in a sorting outlet and for placing it below on the tray conveyor, the shuttle robot also being provided with a safety system arranged to detect the presence of an obstacle being approached in the direction in which the robot is traveling while at a certain safety distance away, and arranged to respond to such detection by reducing the speed of movement of the shuttle robot.

### TECHNICAL FIELD

The present invention relates to an installation for sorting mailpieces that includes a sorting conveyor with sorting outlets and storage trays in which the sorted mailpieces in the sorting outlets are stowed, the storage trays being received in respective ones of the sorting outlets in such a manner as to be removable so as to be handled to be removed from the sorting outlets.

### PRIOR ART

In this type of installation, as in the installation described in Document EP-A-1 393 823, the sorting outlets are sorting outlets having stackers that need to be emptied during the sorting process.

In addition, in this type of installation, the sorting takes place in a plurality of sorting passes, which requires the sorted mailpieces to be brought from the sorting outlets to the inlet of the sorting conveyor a plurality of times in the sorting process.

Storage trays are used for handling the sorted mailpieces. An operative is generally assigned to the task of emptying the stackers of the sorting outlets in handfuls into the storage trays associated with said sorting outlets.

The trays are handled quasi-manually by the operative, which can limit the performance of the installation.

An object of the invention is to remedy that drawback.

### SUMMARY OF THE INVENTION

To this end, the invention provides an installation for sorting mailpieces that includes a sorting conveyor with sorting outlets and storage trays in which the sorted mailpieces in the sorting outlets are stowed, the storage trays being received in respective ones of the sorting outlets in such a manner as to be removable so as to be handled to be removed from the sorting outlets, said installation being characterized in that it further includes a tray conveyor disposed along the sorting conveyor under the sorting outlets, and a shuttle robot suitable for being controlled by a monitoring and control unit for automatically taking hold of a tray in a sorting outlet and for placing it below on the tray conveyor, the shuttle robot being designed with motor-driven wheels for traveling under the control of the monitoring and control unit over a path extending along the sorting outlets of the sorting conveyor in such a manner as to remove the trays automatically from the sorting outlets to the tray conveyor, the shuttle robot also being provided with a safety system arranged to detect the presence of an obstacle being approached in the direction in which the robot is traveling while at a certain safety distance away, and arranged to respond to such detection by reducing the speed of movement of the shuttle robot.

These characteristics contribute to enabling the shuttle robot that automatically handles the trays of the sorting outlets to share the workspace with the operative who is working along the sorting conveyor for emptying the mailpieces from the stackers of the sorting outlets into the storage trays.

This installation may have the following features:
the safety system is arranged in such a manner that, in response to an obstacle being detected that is coming close to the shuttle robot, the shuttle robot is caused “to go into a flight mode” in which it automatically moves away from the obstacle while remaining at said safety distance; and
the shuttle robot is an elevator robot including a telescopic fork that is mounted on an elevator, and a ramp that is outwardly motor-driven and that is disposed under the telescopic fork.

### BRIEF DESCRIPTION OF THE DRAWINGS

The present invention can be better understood and other advantages appear on reading the following detailed description of an embodiment given by way of non-limiting example and with reference to the accompanying drawings, in which:

FIG. 1 is a diagrammatic cross-section view of the sorting conveyor with the shuttle robot that is in a position in which it is facing a sorting outlet;

FIG. 2 shows the shuttle robot of FIG. 1 with a storage tray taken from a sorting outlet;

FIG. 3 shows the shuttle robot of FIG. 2 that is unloading the storage tray onto the tray conveyor;

FIG. 4 is a side view of the shuttle robot with an elevator having a telescopic fork; and

FIG. 5 shows the safety system on the shuttle robot.

### DESCRIPTION OF EMBODIMENTS

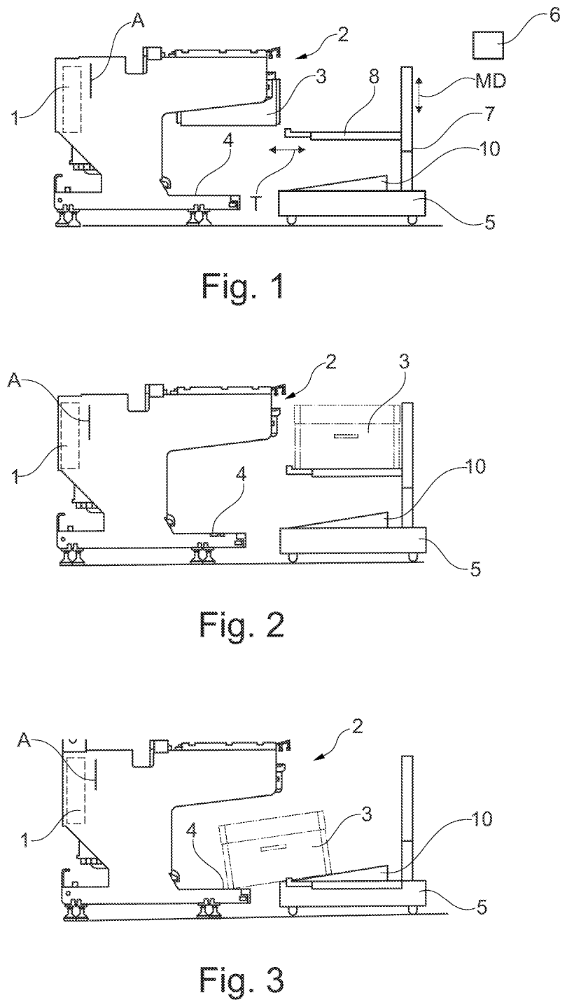

FIGS. 1 to 3 are highly diagrammatic views showing an installation of the invention for sorting mailpieces, with a sorting conveyor 1 having sorting outlets 2 provided with storage trays 3 in which sorted mailpieces are stowed.

FIGS. 1 to 3 are cross-section views of the sorting conveyor 1.

In an installation of the invention, the sorting conveyor 2 may comprise several hundreds of sorting outlets as is well known.

The mailpieces may be letters that are stowed on edge in the trays 3 (small-format tray), large-format mail or “flats” stored flat in the trays 3 (large-format tray), or indeed mixed mail stowed on edge in the trays 3.

In FIGS. 1 to 3, reference A designates a letter that is conveyed on edge in the sorting conveyor and that is stowed on edge in a storage tray 3 of a sorting outlet.

The trays 3 are designed to be detachable from the sorting outlets so as to be handled for being placed in the sorting outlets empty and for being removed from the sorting outlets full or indeed once the sorting process is finished.

In particular, in the installation of the invention, the trays filled with mailpieces may be recycled a plurality of times to the inlet of the installation for the purpose of sorting the mailpieces in a plurality of passes.

In accordance with the invention, the installation includes a tray conveyor 4 that is disposed along the sorting conveyor under the sorting outlets and that is designed to transport the full trays to be removed.

The installation also includes a shuttle robot 5 that is suitable for being controlled by a monitoring and control unit 6 for automatically taking hold of a tray in a sorting outlet and for placing it below on the tray conveyor.

The shuttle robot 5 has an elevator 7 that is suitable for raising or lowering (as indicated by double-headed arrow MD in FIG. 1) a fork 8 that, in this example, is a telescopic fork mounted to move telescopically as indicated by double-headed arrow T in FIG. 1.

The shuttle robot 5 is designed with motor-driven wheels M so as to be suitable for traveling under the control of the monitoring and control unit 6 over a path extending along the sorting outlets 2 of the sorting conveyor.

In particular, the shuttle robot 5 is controlled by the unit 6 to move from sorting outlet to sorting outlet in such a manner as to remove the trays automatically from the sorting outlets to the tray conveyor, the trays being, in this example, filled with letters A stored on edge.

In the installation of the invention, the sorting outlets 2 are sorting outlets having stackers that must be emptied during the sorting process.

An operative OP shown in FIG. 5 therefore moves along the sorting conveyor so as to empty the full stackers one-by-one into the storage trays 3 that are associated with respective ones of the sorting outlets.

As can be understood, the operative moves from sorting outlet to sorting outlet along the path of the shuttle robot.

In accordance with the invention, a safety system based on laser or “LIDAR” scanners 9 provided on two sides of the shuttle robot as shown in FIG. 5 is organized to detect the presence of an obstacle, the operative OP in this example, being approached in the direction in which the robot is traveling while at a certain safety distance away, and organized to respond to such detection by reducing the speed at which the shuttle robot 5 is traveling.

The safety distance is indicated by reference DS in FIG. 5. This distance may be quite short, e.g. two meters.

More particularly, the safety system is arranged in such a manner that if the obstacle and the shuttle robot come closer together than said safety distance DS, the shuttle robot is caused to “go into a flight mode” in which it moves automatically away from the obstacle while remaining at said safety distance.

With this safety system, the operative OP and the shuttle robot 5 can share the same workspace without any risk of collision.

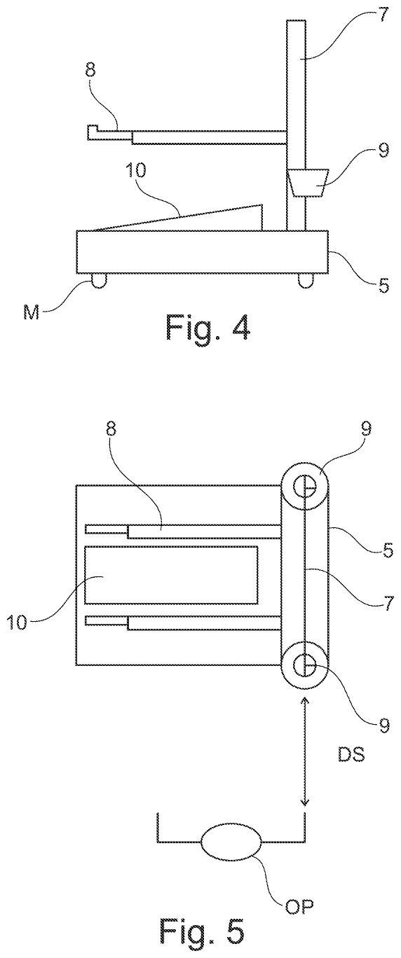

In accordance with the invention, as shown in FIG. 4, a motor-driven ramp 10 is disposed under the telescopic fork so as to transfer a tray automatically from the shuttle robot to the tray conveyor.

The monitoring and control unit 6 can cause the shuttle robot 5 to operate in the following manner.

A sorting outlet 2 is detected by the unit 6 as having a storage tray to be removed, e.g. because it is full of mailpieces.

The unit 6 causes the shuttle robot 5 to move to the location of said sorting outlet 2 as shown in FIG. 1.

The operative OP is positioned at another sorting outlet that is situated between the shuttle robot and the tray 3 to be removed.

On approaching the operative OP, the system 9 detects the presence of an obstacle and, in response, stops the shuttle robot at the safety distance DS.

If the operative OP moves towards the shuttle robot, said robot is caused to go into a flight mode by said safety system.

If the operative moves away from the shuttle robot, the safety system causes the shuttle robot to resume moving towards the tray to be removed.

The shuttle robot is now positioned facing the sorting outlet of the tray 3 to be removed, and the unit 6 causes the fork 8 to lengthen and thus to come into engagement with the tray 3, and then causes the fork 8 to retract, and finally the fork 8 to be lowered towards the motor-driven ramp 10 of the shuttle robot 5.

On coming into contact with the motor-driven ramp 10, the storage tray filled with mailpieces is then transferred automatically to the tray conveyor 4 as shown in FIG. 3.

1. An installation for sorting mailpieces comprising:
a sorting conveyor with sorting outlets;
storage trays in which the sorted mailpieces in the sorting outlets are stowed, the storage trays being received in respective ones of the sorting outlets in such a manner as to be removable so as to be handled to be removed from the sorting outlets;
a tray conveyor disposed along the sorting conveyor under the sorting outlets; and
a shuttle robot suitable for being controlled by a monitoring and control unit for automatically taking hold of a tray in a sorting outlet and for placing it below on the tray conveyor, the shuttle robot being configured with motor-driven wheels for traveling under the control of the monitoring and control unit over a path extending along the sorting outlets of the sorting conveyor in such a manner as to remove the trays automatically from the sorting outlets to the tray conveyor, the shuttle robot also having a safety system arranged to detect the presence of an obstacle being approached in the direction in which the robot is traveling while at a certain safety distance away, and arranged to respond to such detection by reducing the speed of movement of the shuttle robot.

2. The installation according to claim 1, wherein said safety system is configured in such a manner that, in response to an obstacle being detected that is coming closer to the shuttle robot than said safety distance, the shuttle robot is caused to go into a flight mode in which it automatically moves away from the obstacle while remaining at said safety distance.

3. The installation according to claim 2, wherein the shuttle robot is an elevator robot including a telescopic fork that is mounted on an elevator, and a ramp that is outwardly motor-driven and that is disposed under the telescopic fork.

4. The installation according to claim 1, wherein the shuttle robot is an elevator robot including a telescopic fork that is mounted on an elevator, and a ramp that is outwardly motor-driven and that is disposed under the telescopic fork.
